(19) United States
(12) Patent Application Publication
(10) Pub. No.: US 2022/0343762 A1
(43) Pub. Date: Oct. 27, 2022

(54) QUANTITATIVE DRIVING EVALUATION AND VEHICLE SAFETY RESTRICTIONS

(71) Applicant: Intel Corporation, Santa Clara, CA (US)

(72) Inventors: Ignacio J. ALVAREZ, Portland, OR (US); Cornelius BUERKLE, Karlsruhe (DE); Haitao JI, Beijing (CN); Fei LI, Beijing (CN); Fabian OBORIL, Karlsruhe (DE); Johannes QUAST, Karlsruhe (DE); Kay-Ulrich SCHOLL, Malsch (DE); John Charles WEAST, Portland, OR (US); Xiangbin WU, Beijing (CN); Xinxin ZHANG, Beijing (CN); Zhiyuan ZHANG, Beijing (CN); Qianying ZHU, Beijing (CN)

(21) Appl. No.: 17/762,761

(22) PCT Filed: Dec. 27, 2019
(86) PCT No.: PCT/CN2019/129146

§ 371 Date: Mar. 23, 2022

(51) Int. Cl. G08G 1/0968; G06V 20/58; G08G 1/01; G08G 1/0962

(52) U.S. Cl. CPC G08G 1/096855; G06V 20/584; G08G 1/0133; G08G 1/09626

(57) ABSTRACT

One or more processors may be configured to determine one or more prospective routes of an ego vehicle being at least partially controlled by a human driver; receive first sensor data, representing one or more attributes of a second vehicle; determine a danger probability of the one or more prospective routes of the first vehicle using the at least the one or more attributes of the second vehicle from the first sensor data; and if each of the one or more prospective routes of the first vehicle has a danger probability outside of a predetermined range, send a signal representing a safety intervention. Whenever a safety intervention signal is sent, the one or more processors may be configured to increment or decrement a counter.

### CROSS-REFERENCE TO RELATED APPLICATIONS

This application is a National Phase under 35 USC 371 of PCT Application PCT/CN2019/129146, which was filed on Dec. 27, 2019, the entire contents of which are hereby incorporated herein by reference.

### TECHNICAL FIELD

Various aspects relate generally to an SDM, an automated driving system, and methods behavior prediction, qualitative behavior evaluation, and related safety restrictions.

### BACKGROUND

In general, modern vehicles may include various active and passive assistance systems to assist during driving of the vehicle. As an example, an automated driving system (ADS) may be implemented in a vehicle. The automated driving system may be also referred to as an autonomous driving system, autopilot, self-driving system, or the like. In many applications, a vehicle that includes an automated driving system may also include one or more sensors and one or more processors that may be configured to control the movement of the vehicle on a predetermined trajectory. The one or more sensors and the one or more processors may be configured to predict a collision of the vehicle with an obstacle, e.g., with another vehicle, with a wall, with a pedestrian, etc. Although some circumstances lend themselves to successful behavior prediction, other circumstances present too many variables or too much uncertainty for conventional behavioral prediction methods.

Additionally, it may be desirable to evaluate skill or one or more aspects related to the safety of a human driver. Known methods for such evaluation typically rely on details of past negative events, such as motor vehicle collisions. Details such as the fault of a collision, whether one or more statutes or ordinances were violated in the collision, etc. may influence a driver's safety record. Such evaluation strategies do not capture driver behavior that did not result in a negative event, such as a collision. Furthermore, such evaluation strategies may be subjective or may not provide quantitative data.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 depicts an SDM in a schematic view;

FIG. 2 depicts an SDM watchdog implementation example;

FIG. 3 depicts scenarios in which unknown driver intention dictates safety;

FIG. 4 depicts steps for implementation of SDM in an ADAS system;

FIG. 5 depicts SDM calculation and evaluation and reaction;

FIG. 6 depicts an additional safety feature;

FIG. 7 depicts an interface system between the SDM system and a human driver;

FIG. 8 depicts implementation of safety margins;

FIG. 9 depicts a method of risk assessment;

FIG. 10 depicts one or more processors configured to evaluate a vehicle action; and

FIG. 11 depicts a method of driver safety assessment.

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of (objects)”, “multiple (objects)”) referring to a quantity of objects expressly refers more than one of the said objects. The terms “group (of)”, “set (of)”, “collection (of)”, “series (of)”, “sequence (of)”, “grouping (of)”, etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The term “processor” as, for example, used herein may be understood as any kind of entity that allows handling data. The data may be handled according to one or more specific functions executed by the processor. Further, a processor as used herein may be understood as any kind of circuit, e.g., any kind of analog or digital circuit. The term “handle” or “handling” as for example used herein referring to data handling, file handling or request handling may be understood as any kind of operation, e.g., an I/O operation, and/or any kind of logic operation. A processor may thus be or include an analog circuit, digital circuit, mixed-signal circuit, logic circuit, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

Differences between software and hardware implemented data handling may blur. A processor, controller, and/or circuit detailed herein may be implemented in software, hardware and/or as hybrid implementation including software and hardware.

The term “system” (e.g., a computing system, an automated driving system, a safety system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

As used herein, the term “memory”, and the like may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa.

The term “vehicle” as used herein may be understood as any suitable type of vehicle, e.g., any type of ground vehicle, a watercraft, an aircraft, or any other type of vehicle. In some aspects, the vehicle may be a motor vehicle (also referred to as automotive vehicle). As an example, a vehicle may be a car also referred to as a motor car, a passenger car, etc. As another example, a vehicle may be a truck (also referred to as motor truck), a van, etc. As another example, a vehicle may be bicycle or a motorbike. In other aspects, the vehicle may be a partially or fully autonomously flying drone (e.g., an aeronautical taxi) having, for example, a pilot and/or one or more passengers onboard.

The term “lane” with the meaning of a “driving lane” as used herein may be understood as any type of solid infrastructure (or section thereof) on which a vehicle may drive. In a similar way, lanes may be associated with aeronautic traffic, marine traffic, etc., as well. The term “road” with the meaning of a “traffic road” as used herein may be understood as any type of solid infrastructure (or section thereof) on which a vehicle may drive. In a similar way, roads may be associated with aeronautic traffic, marine traffic, etc., as well.

According to various aspects, information (e.g., road information, obstacle position information, etc.) may be handled (e.g., processed, analyzed, stored, etc.) in any suitable form, e.g., data may represent the information and may be handled via a computing system.

A risk that may originate from an obstacle, e.g., a risk for a potential collision, may be treated in an analysis (as described herein) as a potential collision event assigned to the obstacle and a reference vehicle. The reference vehicle may be also referred to as an ego-vehicle. An ego-vehicle may be a vehicle that includes the SDM or that includes the automated driving system including the SDM. In general, an ego-vehicle may be a vehicle that serves as reference in a lane coordinate system. The ego-vehicle or the perspective associated with the ego-vehicle may define, for example, reference driving directions, etc.

In some aspects, one or more sensors may be used for sensing one or more objects that could be one or more obstacles in the vicinity of the one or more sensors to provide, for example, obstacle position information and/or other real world data. A range imaging sensor, for example, may allow range information (or in other words distance information or depth information) to be associated with an image, e.g., to provide a range image having range data associated with pixel data of the image. This allows, for example, for providing a range image of the vicinity of a vehicle including range information about one or more objects depicted in the image. According to various aspects, position data associated with absolute positions of objects or positions of objects relative to a vehicle may be determined from sensor information.

In one or more aspects, a driving operation (such as, for example, any type of safety operation, e.g., a collision avoidance function, a safety distance keeping function, etc.) may be implemented via one or more on-board components of a vehicle, e.g., via an automated driving system. The one or more on-board components of the vehicle may include, for example, a one or more sensors (e.g., one or more cameras, one or more radar sensors, one or more light detection and ranging (LIDAR) sensors, etc.), a computer system, etc., in order to detect obstacles (e.g., at least in front of the vehicle) and to trigger an obstacle avoidance function (e.g., braking, steering, etc.) to avoid a collision with a detected obstacle.

According to various aspects, a computing system may be used to implement one or more functions described herein. The computing system may include, for example, one or more processors and one or more memories, as example. The computing system may be communicatively coupled to one or more sensors (e.g., of a vehicle) to obtain and analyze sensor data generated by the one or more sensors, or the computing system may be coupled to, or may include, a sensor module that obtains and analyzes sensor data generated by one or more sensors.

Several aspects are described herein exemplarily with reference to a motor vehicle, wherein another motor vehicle represents an obstacle in a vicinity of the motor vehicle. However, other types of vehicles may be provided including the same or similar structures and functions as described exemplarily for the motor vehicle. Further, other obstacles may be considered in a similar way as described herein with reference to the other vehicles.

According to various aspects, an SDM may be provided that increases safety during operation of an automated driving system or any other suitable autonomous or partially autonomous system. This may also increase society's trust of automated driving systems. In general, a need for safety assurances in automated driving may become increasingly critical with the accelerating widespread deployment of automated vehicle fleets. Beyond functional safety, it may be desired to guarantee the operational safety of these vehicles. To that end, a so-called Safety Driving Model (SDM) may be introduced including a model-based approach to safety. Various aspects of the present disclosure may be related to an SDM Open Library, i.e., an open source executable implementation of SDM. In some aspects, the SDM Open Library may be integrated with automated driving software pipelines as an SDM overseeing decision making of driving policies. As an example, the SDM may be integrated with a software platform to provide safety validation. Additionally or alternatively, the principles and methods disclosed herein may be operated with one or more propriety or “closed” SDM libraries.

In general, automated driving systems with capabilities, for example, beyond level 3 (L3+) may require significant investments in operational safety, in particular in the areas of scenario development and formal verification, testing and validation tools. Level 3 may be referred to as a level of driving automation in which drivers can safely turn their attention away from driving tasks, e.g., drivers can send a messages via a communications system, watch a movie, or the like, and wherein the vehicle may handle situations that call for an immediate response, like emergency braking. However, in a level 3 driving automation, a driver has to be prepared to intervene within some limited time upon notification. An SDM may include a technology neutral model for safety that can be used to define and measure whether an automated vehicle is driving safely. An SDM may in some aspects formalize an interpretation of a common sense definition of what it means to drive safely, and may define what it means for an automated vehicle to drive safely on its own and how it should exercise reasonable caution to protect against the unsafe driving behavior of others.

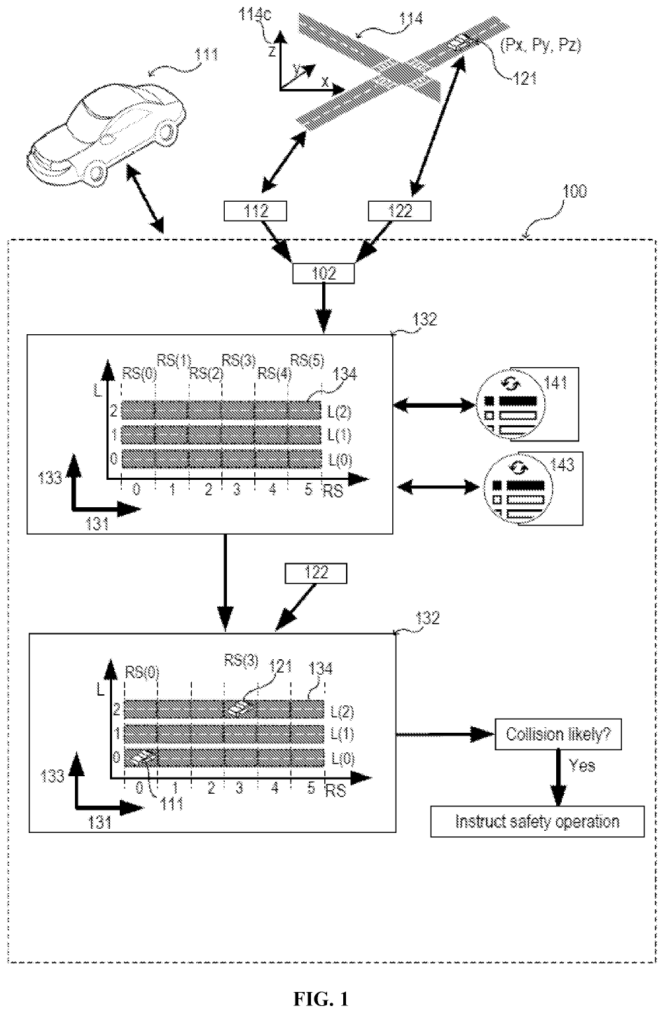

FIG. 1 illustrates an SDM 100 in a schematic view, according to various aspects. The SDM 100 may include one or more processors 102. The one or more processors 102 may be part of a computing system of a vehicle. The SDM 100 and/or the one or more processors 102 of the SDM 100 may be associated with an ego-vehicle 111. The SDM 100 and/or the one or more processors 102 of the SDM 100 may be integrated into or communicatively coupled with an automated driving system of the ego vehicle 111, as an example.

According to various aspects, the one or more processors 102 may be configured to receive road information 112. In some aspects, the road information 112 may be provided to the one or more processors 102 from a sensing module of an automated driving system. However, the road information 112 may be provided to the one or more processors 102 with any suitable technique, e.g., the road information 112 may be transmitted wirelessly to a receiver that may be communicatively coupled with the one or more processors 102. The road information 112 may represent a geometry and/or other properties of one or more roads 114. As an example, the road information 112 may include a width of the one or more roads 114 along the course of the respective road, a curvature of the one or more roads 114 along the course of the respective road, or any other geometric property as a function of a position along the respective road. According to various aspects, the road information 112 may represent the geometry of the one or more roads 114 in a Cartesian coordinate system 114c. As an example, the road information 112 may represent a road map in Cartesian coordinates 114c or the road information 112 may be obtained from a road map in Cartesian coordinates 114c.

According to various aspects, the one or more processors 102 may be configured to receive obstacle position information 122 associated with a position of an obstacle 121 on the one or more roads 114. The position of the obstacle 121 may be defined in two-dimensional coordinates (Px, Py) or, where appropriate, in three-dimensional coordinates (Px, Py, Pz). The obstacle 121 may be, according to various aspects, another vehicle driving on the road. However, the obstacle 121 may be a pedestrian, a cyclist, a construction side, or any other static or movable obstacle that is relevant for safety aspects in traffic.

According to various aspects, the one or more processors 102 may be configured to determine a lane coordinate system 132 based on the received road information 112. The lane coordinate system 132 may include a plurality of lane segments 134. In the lane coordinate system 132, one or more first sets of lane segments may represent one or more lanes L(0), L(1), L(2) of the respective road. Each of the one or more lanes L(0), L(1), L(2) may include lane segments 134 arranged along a first (e.g., longitudinal) direction 131. Further, in the lane coordinate system 132, second sets of lane segments 134 may represent road segments RS(0), RS(1), RS(2), RS(3), RS(4), RS(5) of the respective road. Each of the road segments RS(0), RS(1), RS(2), RS(3), RS(4), RS(5) may include lane segments 134 arranged along a second (e.g., lateral) direction 131. It is noted, that exemplarily a road with three lanes L and six road segments RS is illustrated in FIG. 1; however, a road may include more or less than three lanes L and more or less than six road segments RS.

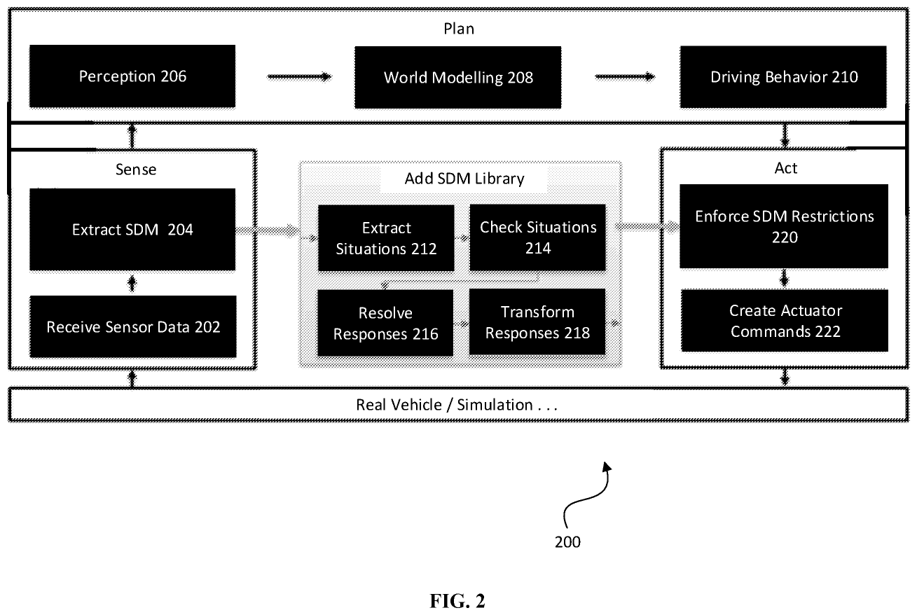

As an example, the road illustrated in the lane coordinate system 132 in FIG. 1 may include three times six lane segments 134. Each lane segment 134 may be identified by the number of a corresponding road segment RS and a number of a corresponding lane L as a tuple (RS, L). As example, a first lane segment (0, 0) may correspond to road segment 0 and lane 0, a second lane segment (1, 0) may correspond to road segment 1 and lane 0, [ . . . ], a seventh lane segment (0, 1) may correspond to road segment 0 and lane 1, an eighth lane segment (1, 1) may correspond to road segment 1 and lane 1, [ . . . ], etc. According to various aspects, a length information 141 and a width information 143 may be assigned to each of the lane segments 134. The length information 141 may represent at least a minimal length and a maximal length of the respective lane segment 134. This minimal length and maximal length may be a function of a curvature of a corresponding part of the respective road, as exemplarily illustrated in more detail in FIG. 2A. The width information 143 may represent at least a minimal width and a maximal width of the respective lane segment 134.

In a similar way, a height information (not illustrated) may be assigned to each of the lane segments 134. The height information may represent at least a minimal height and a maximal height of the respective lane segment 134. This minimal height and maximal height may be a function of a three-dimensional geometry of a corresponding part of the respective road, for example, in the case that three-dimensional coordinates are to be considered for the roads.

According to various aspects, the one or more processors 102 of the SDM 100 may be further configured to determine a position of the obstacle 121 relative to the ego-vehicle 111 in the lane coordinate system 132 based on the obstacle position information 122. As exemplarily illustrated in FIG. 1, the ego-vehicle 111 may have a position in the lane segment (0, 0) and the obstacle 121 (e.g., another vehicle participating in traffic) may have a position in the lane segment (3, 2).

According to various aspects, the one or more processors 102 may be configured to determine a potential collision event (e.g., a likelihood for a collision of the ego-vehicle 111 with the obstacle 122) based on the determined relative position of the obstacle 121. In the case that the potential collision event is determined (e.g., if a determined likelihood for a collision is at or above a predefined threshold), the one or more processors 102 may be configured to instruct one or more safety operations to avoid a potential collision.

In some aspects, vehicles may use road and lane markings to identify driving corridors (also referred to as lanes). Perception and localization of these lane boundaries, as well as of dynamic and static obstacles in the environment may constitute a basis of a driving situation coordinate system. Vehicles may use road or lane-based coordinate systems to derive lateral and longitudinal safety distance calculations for planning their path and avoid driving infractions and collisions.

According to various aspects, the SDM 100 described herein may use a lane coordinate system 132 to abstract from changing road geometries in the calculations of vehicle constellations, safe distances, and proper response to situations getting dangerous. According to various aspects, a bijective embedding of a lane coordinate system may be used to describe general road geometries for every situation. Various aspects described herein may be related to an actual transformation of the observed real world situation between two vehicles (e.g., an ego-vehicle and another vehicle) into a concrete lane based coordinate system to be able to apply one or more safety calculations defined by, for example, SDM. Ignoring, for example, deviations of a real world situation from an ideal model description might lead to inconsistencies and wrong safety estimations in real world conditions.

According to various aspects, a situation-based coordinate system may be constructed that may include transformations from a Cartesian road definition, for example, from a high definition map, into a situation-specific lane coordinate system that may describe a constellation of one or more pair-wise situations between two vehicles. This situation-based lane coordinate system may be used to translate real-world road geometries into a conditional framework as, for example, required by SDM to perform accurate safety guarantee calculations, thus abstracting real-world complexity from the clean, formally proven, safety calculations of SDM and expanding the usefulness of SDM into more real-world conditions.

One of the commonly used approaches for mapping information for maneuver planning may be through the use of lanelets, which describe small or irreducibly small lane segments characterized by its left and right bounds. Lanelets may allow for composition of complex road situations and incorporation of tactical information for maneuver generation such as rule-compliant intersections. Another mapping approach may be, for example, via Open Street Map, a crowdsourced database promulgated by the OpenStreetMap Foundation, which provides free, geographic street maps. Open Street Map models the world with nodes, ways, and relations and is useful to represent topological information. Another map representation may be OpenDrive (also written as OpenDRIVE), which is managed by VIRES Simulationstechnologie GmbH and the OpenDRIVE community. OpenDrive is an open format specification to describe a road network's logic, and thus may provide a standardized road network file format. It may be useful to provide a common interface between driving simulators at a macroscopic (e.g., road topology) level. The current techniques may be successful at solving particular mapping problems and may provide a basis for high definition maps. However, they may focus on static road elements and may not describe dynamic objects. Both may be useful for a situation-based coordinate system in SDM. According to various aspects, the SDM 100 described herein may support current techniques and may provide a bridge between a mapping tool and a safety tool (e.g., SDM).

According to various aspects, any given road shape may be converted by the SDM 100 into a (e.g., simplified) situation-based coordinate system where, for example, lanes are straight and have the same width, while maintaining worst-case assumptions of the distances between the vehicles. Such a coordinate system may be used by SDM to determine lateral and longitudinal safe distances to vehicles and obstacles on the road. By assigning width intervals and length intervals (or at least a minimum and a maximum for the width and the length) to the lane segments, an effective mapping from real world road geometries to a simplified coordinate environment may be possible on which formal methods can be applied to derive safe behaviors. Such a conversion may be used, for example, to carry out an SDM implementation under real-world road geometries, but can be valuable for all other applications that need to calculate safety distances between objects on a given road.

According to various aspects, it may be of advantage to switch from a Cartesian space into a road/lane-based coordinate system for calculating (e.g., safety) distances between vehicles. According to various aspects, a situation-based coordinate system may be used, which may be understood as a specific lane-based coordinate system generated for the respective traffic situation.

Driver Assist technology is designed to support human limitations at the steering wheel, such as, for example, limitations resulting from driver inattention, reckless behavior, and/or fatigue. Existing technologies (e.g., lane keeping assist and automatic cruise control with stop and go functions) generally support lateral and longitudinal driving under certain conditions (e.g. highway roads with good weather). It is expected that automated driving technology will expand to include more driving domains and environmental conditions. As this occurs, automated driving technology is like to move from SAE Level 1 automation towards level 4.

Progress is also being made on fully automated driving (AD) technologies, such as level 4 and level 5 operation, or in level 3 operation when the vehicle is operating in automation mode, which require safe operation without human intervention. To make level 4 and level 5 operation possible, one or more mathematical models, including but not limited to SDM, may be utilized to help assure a collision free traffic flow. The SDM may operate in conjunction with one or more mapping and routing models (“RMM”), which may utilize stored or predetermined mapping or navigation information; map surroundings based on local sensors and/or the predetermined mapping or navigation information; and determine relationships (i.e., relationships from which the vehicle(s) can make mathematical decisions related to driving) using the mapped surroundings.

These operational safety systems (SDM, and SDM along with RMM) may perform one or more watchdog functions, or safety shield functions, and may generally monitor the planning subsystem of the automated vehicle and enforcing vehicle actuation restrictions when dangerous situations are detected.

FIG. 2 depicts an SDM watchdog implementation example 200. In this figure, a vehicle including one or more sensors must receive sensor data 202 and extract an appropriate SDM resource 204 for processing and perception of the sensor data. The sensor data may be sent to one or more processors within the vehicle, or elsewhere depending on the implementation, in which the sensor data may be perceived 206. This may include, for example, evaluating the sensor data relative to one or more thresholds or predetermined acceptable ranges; analyzing the data for patterns or specific attributes; performing artificial intelligence analyses on the data, or otherwise. Using the perceived data, the one or more processors may model the surroundings of the vehicle 208. Using the model, and depending on the circumstances using the model in conjunction with sensor data, the driving behavior 210 may be understood as it relates to the surroundings. This may enable aspects of the driving behavior to be evaluated, such as safety of particular driving decisions, risk of damage or collision, etc. The SDM may include a library of known situations 212, which may be used to understand sensor data, the modeling, the driving behavior, or otherwise. The SDM may evaluate its situations from the library 214 and resolve responses based on known or extracted situations 216. Based on these resolutions, responses may be transformed 218, which may be used to make one or more subsequent decisions. That is, the SDM may implement one or more restrictions 220, said restrictions being implemented at least based on the determined driving behavior 210 and/or the transformed responses 218. Said restrictions may be any driving restrictions according to an SDM, but may include, for example, limits on velocity, limits on acceleration, forced deceleration, limits in route, limits in proximity between vehicles, or otherwise. Based on the imposed restrictions 220, the one or more processors may create actuator commands 222, which may be implemented to cause the vehicle to carry out one or more of the restrictions. In this manner, the SDM systems may check planning subsystem behaviors and, if necessary, enforce restriction.

While technologies like SDM are presented in the framework of full automation, they cannot be directly applied in the field of Driver Assistance to avoid human error to cause accidents. The application of SDM to support human “free will” driving may present significant complications, given that the planned route is usually known to SDM but a human driver's intent will not be. For example, in the case of a fully autonomous vehicle, the route of the vehicle is known to the vehicle, whereas in case of a human driver, the route may need to be considered as unknown, under certain circumstances. During some vehicle operations, human drivers may utilize a navigation system, into which a destination may be programmed, and from which a route may be generated. The route may be a strong indication of the driver's intended route; however, even under this circumstance, such a route in a navigation system may not correspond exactly to a human driver's intended route.

As SDM systems become increasingly robust, and particularly given their comprehensiveness over many driving assist operations that are currently available, it may be desirable to employ one or more SDM systems for driving assist technology. The problem here becomes that SDM systems are generally configured to avoid any possibility of situations that pose significant risks of danger, which cannot be effectively achieved as a driver assist model, without additional modification. This may be best understood by way of example.

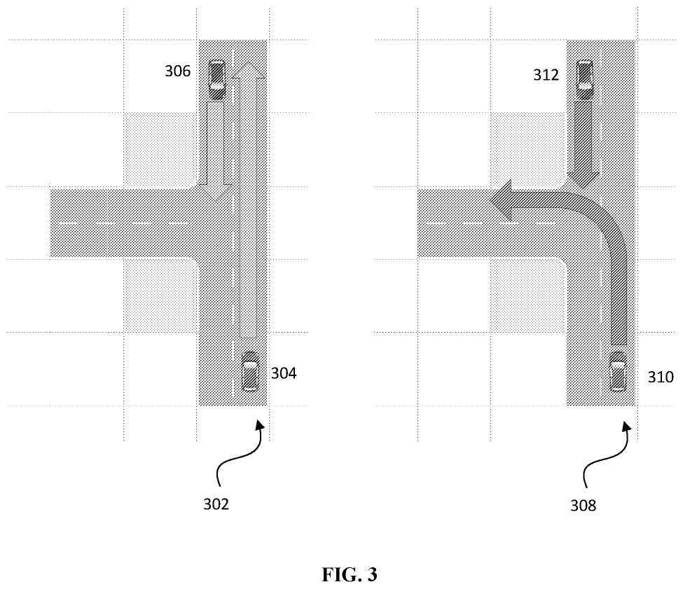

FIG. 3 depicts two scenarios 302 and 308, for which driver intention (which may be unknown to the vehicle) determines the safety of the situation. In situation 302, the ego vehicle 304 is proceeding northbound and encounters unknown vehicle 306. The ego vehicle 304 may be a human-operated vehicle including one or more driver assist modules that are implemented as an SDM. Assuming that vehicle 306 will continue on a southbound path, there are two options for the path of ego vehicle 304: continuing northbound, or making a left turn. The intended path of ego vehicle 304 (which is determined by the human-operator) may be unknown to the vehicle/the one or more processors performing SDM evaluation. In 302, ego vehicle 304 is proceeding on a northbound path, which is a safe route and provides no reason for alarm. In contrast, in 308, the ego vehicle 310 may make a left turn in front of vehicle 312. This may be understood as a high-risk activity, for which one or more restrictions or actions should be implemented. Because the SDM is unaware of the driver's intentions, the SDM must consider that the driver may either proceed northbound (a safe route) or may make a left turn (sees a dangerous route). As one potential route may be catastrophic, the SDM, which may otherwise be programmed to take action when even one possibility is associated with the danger outside of an acceptable threshold, may implement one or more restrictions or actions to prevent the scenario in 308. Because the SDM would be expected to frequently encounter such unknown situations in which at least one scenario can present danger, when utilized in the context of a human-operator, simple implementation of a conventional SDM within a driver assistance system is likely to be counterproductive and result in user dissatisfaction.

Thus, a method to apply SDM-type safety restrictions for human driven vehicles is proposed. This system may be in addition to, or as a replacement of, current Advance Driver Assistance Systems (“ADAS”). This may include the enforcement of safe driving behaviors on normal roads, but also on intersections, lane changes, unstructured roads, and areas with occlusions. Hence, the principles and methods disclosed herein expand the use of SDM from full automation to the field of ADAS (used herein to indicate assistance to human drivers). Furthermore, by enabling SDM restrictions on human drivers, a safer solution for mixed deployment scenarios in which automated vehicles can more easily coexist with manually driven cars.

For the purposes described herein, it may be assumed that the human driven vehicles are equipped with the necessary sensing capabilities to provide onboard SDM systems with a world model through which to evaluate safety maneuvers in the current situation or/and communication capabilities to receive this information through wireless methods from infrastructure systems. This assumption is very reasonable, as many modern vehicles are already come with required sensing technology (e.g. cameras, radar and laser scanner sensors).

Several safety related ADAS systems exist today in the market as commercial application, but each focuses on distinct, limited domains where it assists/tries to make driving safer. For example, Lane Departure Warning/Lane Keeping Assist warns/assists steering when vehicle moves out of its lane; (Forward) Collision Avoidance system (aka. pre-crash system) prevents or reduces impact of collisions (although this often only works for forward collisions to other vehicles, some systems also work in more complex scenarios and with other road users (pedestrians, cyclists, etc.)); and Blind Spot Assist warns if there is a traffic participant on a neighboring lane inside the vehicles blind spot.

Existing ADAS solutions are not comprehensive (thus the categorization of SAE Level 2 automation), and thus fail to avoid collisions in many situations (for example intersections and/or unstructured roads). In addition, these approaches do not provide a public, trustable and validated mathematical safety model that better ensures that the vehicle will not make a decision that would actively cause an accident. Furthermore, typical driver assistance systems cannot evaluate intersection priorities, and hence avoid that a human driver erroneously takes priority instead of giving priority. Moreover, the state-of-the-art ADAS approaches are generally forward looking only, i.e. it is possible to perform reckless cut-in maneuvers and dangerous lane-merges for traffic traveling behind the ego vehicle. Finally, the conventional ADAS solutions are not designed to keep the vehicle in a safe state. Instead, systems such as brake assist only apply corrections in emergency (very critical situations), i.e. much later and on a much lower level than the SDM-like ADAS solution.

SDM focuses on AD, but ADAS has different requirements (for example how to handle “priority is given not taken” for priority-to-right intersections, without having route/map information). Hence, they may not be directly applicable as ADAS systems.

The principles and methods disclosed herein may expand the application of safety models for automated driving (such as SDM) to driver assistance systems guaranteeing safety for human driven vehicles.

This may be achieved by substituting the a-priory knowledge of the AV trajectory with a prediction of human driver intention that operates under uncertainty. This allows the application of SDM-type safety restrictions not only in defined lane segments but also in complex maneuver operations such as lane-changes, intersections, etc.

The principles and methods disclosed herein may expand the applicability of SDM from a limited set of automated vehicles to any current vehicle L2 vehicle. The adoption in these vehicles of the SDM-ADAS system may automatically convert them to L2+ making driving safer for the end users. A comprehensive collision avoidance ADAS could reduce the number of accidents and make non-AD driving safer.

The application of SDM type logic as Driver Assistance may require several adaptations to the SDM system, particularly for the handling of intersections and priorities. The root cause for this is that in the Non-AD case, important information, such as the vehicle route is missing.

SDMs may create a situational model of the ego vehicle and the other traffic participants based on the road structure (geometry, intersections and priorities) and the planned route. Those situations may then be evaluated, and if there is a dangerous one, which might lead to a collision, a proper response to that threat may be created (braking, steering, etc.).

When using SDM as a safety ADAS in a non-AD vehicle, the route may not be known to the system. Hence, creating situations as described above for all possible routes and evaluating them all together is unlikely to be successful. Consider, for example the scene depicted in FIG. 3, in which one route leads to an unsafe situation, and in which another route is safe. As a result, a counter-action would be triggered in this scene (i.e. braking), as there is at least one unsafe route. This is due to the fact that the design of SDM (having fully automated vehicles with known routes in mind) causes a response if there is a single dangerous situation. This means that the direct application of such a safety layer as ADAS could trigger braking/steering actions if there is a single dangerous situation, even though it might not be related to the route that will be taken. This can cause unwanted and unexpected interventions to the vehicles' trajectory (i.e., by braking and/or steering).

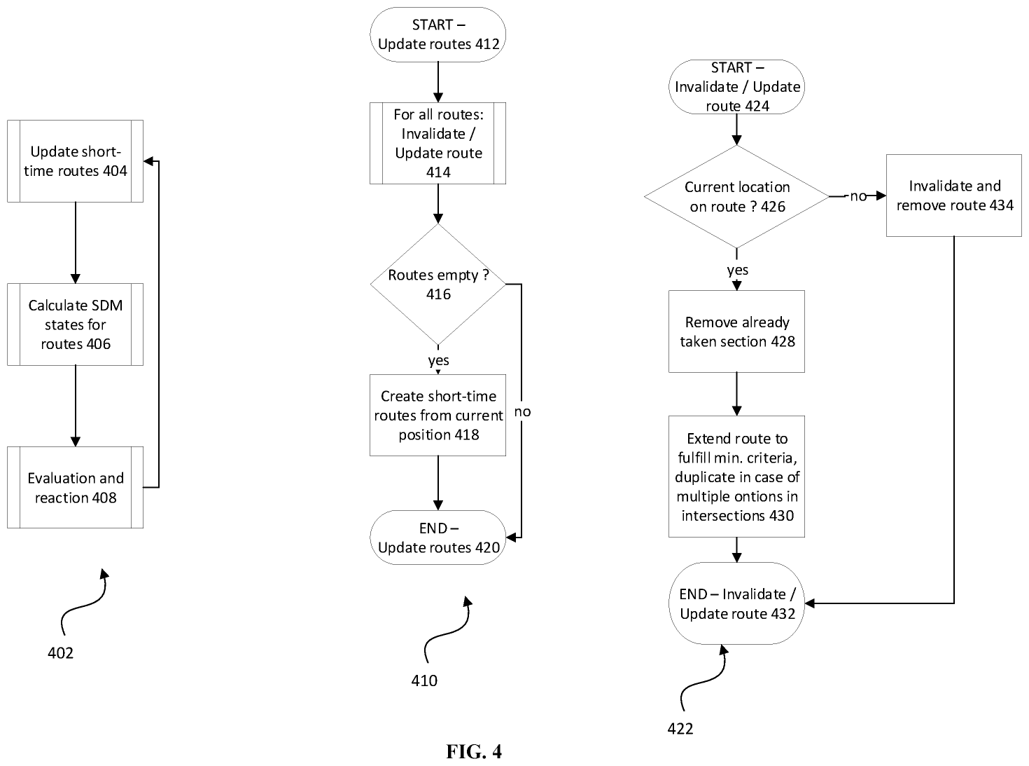

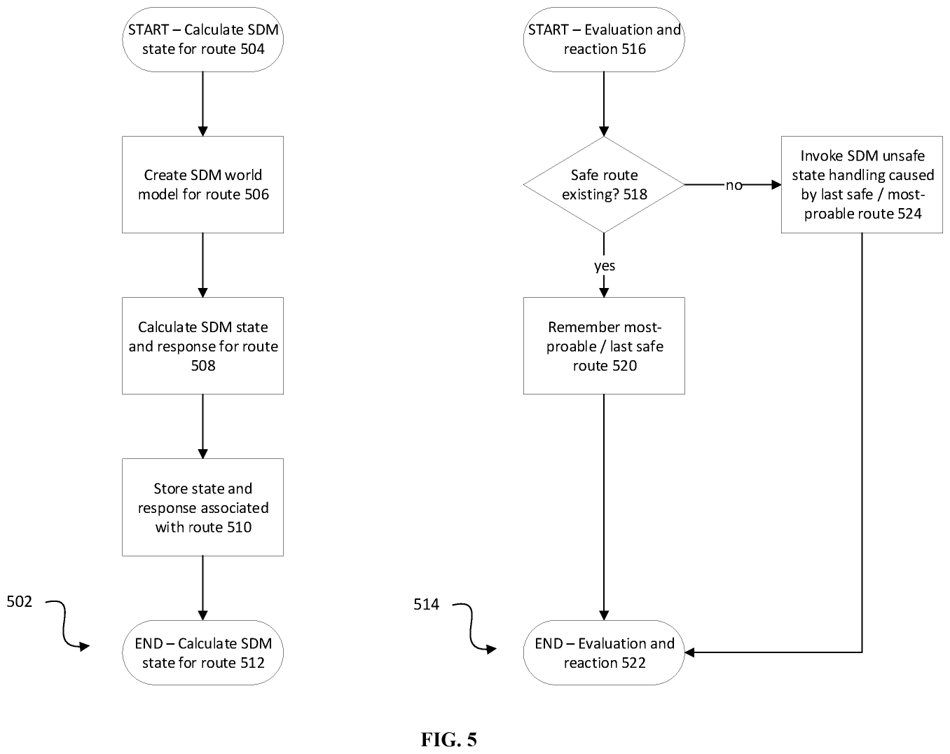

Hence, to use SDM in an ADAS system, it may be desired to expand the methodology to the steps that are depicted in FIG. 4 and FIG. 5.

FIG. 4 depicts steps for implementation of SDM in an ADAS system. In 402, a routine is presented in which short time routes are updated 404, the SDM state for the short-term routes is calculated 406, and the SDM state is evaluated and necessary reactions are chosen/implemented 408. In 410, routes are updated 412. The SDM may have a number of pre-existing routes, and these routes may be updated or invalidated 414. That is, based on decisions made by the driver or other factors, one or more pre-identified routes may no longer be applicable (such as, a driver has turned away from the route, or otherwise). It is determined whether the selection of routes is empty 416, that is whether any updated routes remain. If one or more routes remain, then short time routes are created from the current position 418, and the routes are considered as updated 420. Assuming that no routes exist after an update 416, then the route update routine is ended 420. 422 shows a procedure for invalidating/updating routes 424. The current location may be determined, and the routes may be assessed to determine whether the current location is on the route 426. If the current location is on the route, then an already traveled upon section of that route may be removed or deleted 428. The remaining route may be extended based on any desired criteria, and the route may be duplicated in case there are multiple options for a given intersection 430. At this point, the routes may be considered updated 432. In the event that the current location of the vehicle is not on a given route 426, that entire route may be invalidated and removed 434.

FIG. 5 depicts SDM calculation and evaluation and reaction, according to an aspect of the disclosure. In 502, the SDM state for the route may be calculated 504. Using available data (e.g. sensor data) and SDM world model may be calculated for route 506. The SDM state and a response for the route may then be determined 508 and the stored state and response may be associated with the route 510. In this manner, the SDM state for the route is calculated 512. 514 depicts the evaluation and reaction to an SDM state 516. Based on the SDM state for the various routes, it is determined whether a safe route exists 518. If a safe route exists, then the most probable route may be determined or the last safe route may be evaluated or remembered 520. In this manner, the SDM state may be evaluated and reacted to 522. If it is determined that no safe route exists 518, then the SDM unsafe estate handling may be invoked 524. In invoking the SDM unsafe state handling, the vehicle may be caused to implement the last safe route or the most probable safe route 524.

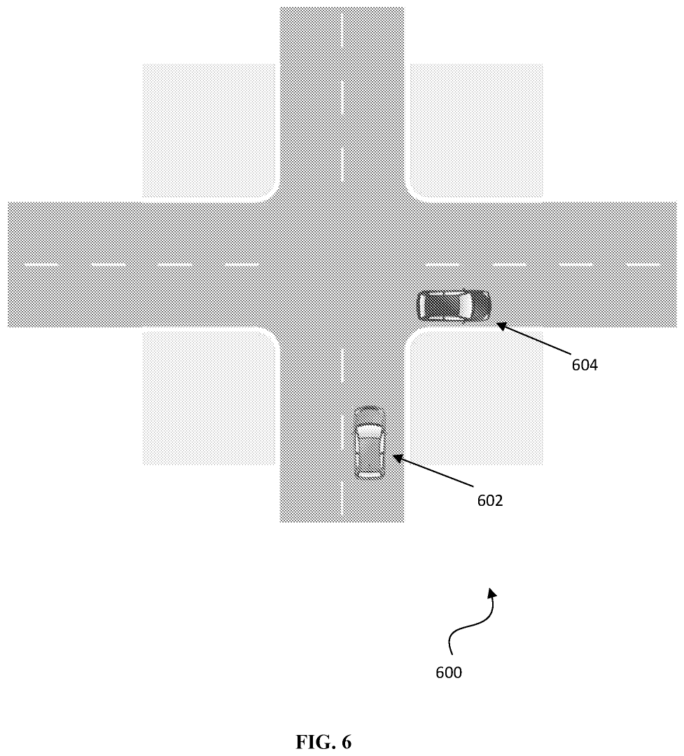

FIG. 6 depicts an additional safety feature, according to an aspect of the disclosure. In this figure, an intersection 600 is depicted, having an ego vehicle 602 and an additional vehicle 604. In this case, the additional vehicle 604 is stopped at the depicted location. The ego vehicle 602, in view of its world view, may identify two possible routes; proceeding straight, or turning left (turning right does not appear to be a valid route, as the vehicle 604 is stopped and would preclude a right turn). Because neither of the two possible route options involves a right turn, and thus does not involve the stopped vehicle 604, the ego vehicle 602 may be generally agnostic to the stopped vehicle 604. In the event, that the ego vehicle 602 begins to drift to the right, the ego vehicle 602 could conceivably collide with the stopped vehicle 604. As such, an additional safety measure could be implemented in the situation, in which the ego vehicle 602 is caused to maintain a position in its lane (e.g., to stay within its lane). This may prevent the ego vehicle from drifting in a direction that is not contemplated by the available routes.

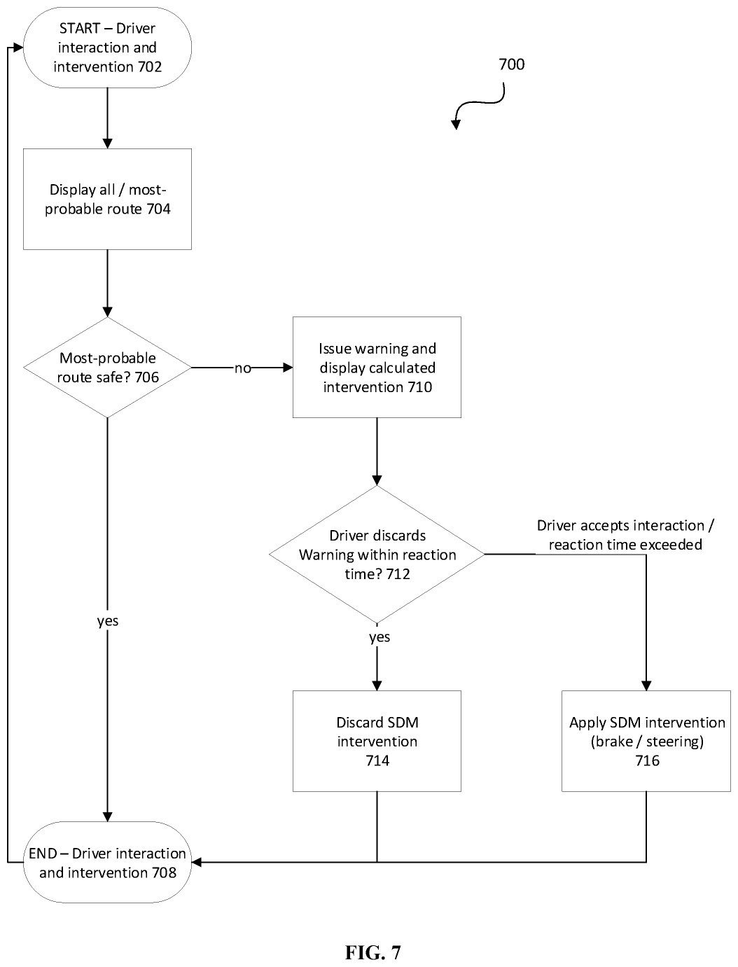

FIG. 7 depicts an interface system 700 between the SDM system and a human driver. In the system, driver interaction and possible intervention may be evaluated 702. Based on the SDM analyses described above, all or some, probable route(s) may be displayed to a human driver 704. The display may be using any method whatsoever, whether a vehicle display, a windshield display, a mobile device display, or even “displayed” using one or more audio signals, one or more haptic signals (i.e., seat bussing, steering wheel vibrating, or any other haptic signal), commands, or instructions. The vehicle may determine whether a most probable route is safe 706. If it is determined that the most probable route is safe, then no intervention is necessary. If, however, it is determined that the most-probable route is not safe, then the vehicle/SDM may issue a warning and/or display calculated interventions 710. The driver may, for example, be given an opportunity to disregard the warning 712. This may be useful in situations, for example, when the driver has no reason to believe that a significant danger exists. Assuming that the driver disregards a warning, within a predetermined window of time 712, the SDM intervention may be discarded 714. Assuming that the driver does not disregard the warning within a predetermined time 712, then the SDM intervention may be implemented 716.

The use of disregarding a warning may be used with respect to this example to mean that the driver is given an opportunity to indicate that a given warning should not be implemented as an SDM intervention. For example, should a driver receive a warning of a possible danger, the driver may be presented with an assessment of the danger and or one or more routes for actions to avoid the perceived danger. The driver may be given a period of time to respond to this morning of a perceived danger. In that period of time, the driver may accept that the danger exists, ignore the warning of danger, or affirmatively state that the warning should not be implemented as an SDM intervention. In the event that the driver accept that the danger exists, the SDM intervention may be implemented without further delay. If the driver ignores the warning, a timer may be implemented, the expiration of which may trigger implementation of the SDM intervention. In this manner, the driver is given a fair warning and a chance to react, and the lack of a reaction may lead to SDM intervention. If the driver affirmatively states that the warning should not lead to an SDM intervention (previously referred to as discarding the SDM intervention), then the SDM intervention may not be implemented.

Furthermore the possible routes could be rated and their probability could be influenced by external measures taken from the vehicle or the driver, such as: Turn signal; Speed profile (reducing speed is an indicator for the intent to turn); Planned route (e.g., from the satnav system); Lanes taken (e.g. turning lane); and/or Wheel angle.

For example, if the driver activates the right turn signal, the proposed SDM system might disregard all other possible routes except the one turning right. While this solution allows handling of most of the intersection situations, there are some conditions, in which it may not be sufficient, as depicted above in FIG. 6.

Following the previously described algorithm, the SDM-ADAS vehicle would have two possible route options, namely straight and left. However, for these, the stopped vehicle may be ignored, as it is not relevant for these routes. Hence, no matter which movement the SDM-ADAS vehicle performs, as there is always a valid route available, SDM would not intervene. As a result, if the SDM-ADAS vehicle drifts to the right, it will eventually collide with the stopped car.

To overcome this issue, the SDM may require the ego vehicle to stay on the road. This idea can be extended for these particular intersection situations, to require the vehicle to stick the last valid route, and hence to make the aforementioned algorithm work. According to an aspect of the disclosure, the use of this extension is not required in situations, where all routes are valid/invalid.

Another feature that is required for the intersection use case is a user interface system between the SDM-ADAS and the human driver. It may be required to notify the driver about dangerous and valid routes, as well as routes that will be assisted based on the input for example from navigation input. Second, the driver should have the ability via this system to overwrite the pre-selected route, or disable SDM-ADAS for a short amount of time. See FIG. 7 for an example.

In non-intersection scenarios, where only conflicts have to be resolved with traffic participants that travel in the same or opposite direction, the conventional SDM rules may be able to be applied. To obtain the required road segments for the underlying analysis, it may be advisable to use the same route calculation/update scheme that was introduced above, with respect to at least FIG. 3.

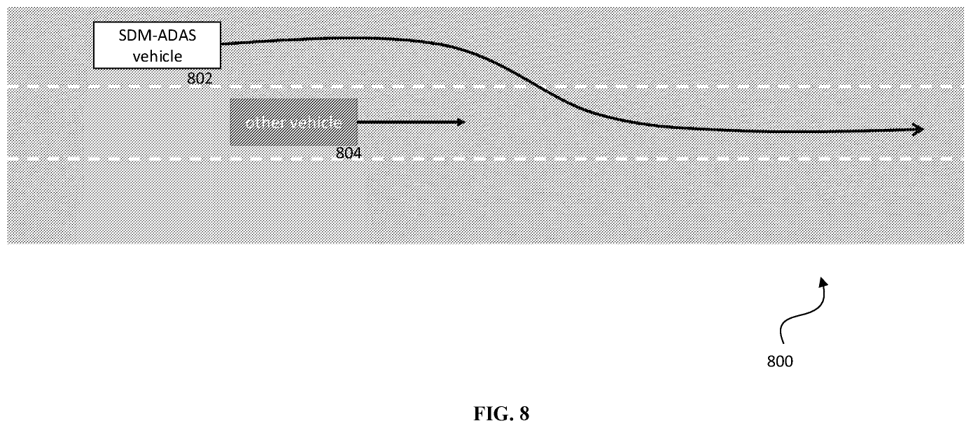

Using an SDM-ADAS for these situations may improve the safety of human operated vehicles, as the vehicle cannot perform reckless cut-in/overtake maneuvers, nor can they diffuse to a neighboring lane if this causes conflicts with traffic traveling in the opposite direction. This may, for example, avoid risky overtake maneuvers, and ensure that merges into flowing traffic are only performed considering common sense safety margins, as depicted in FIG. 8. In this figure, the ego vehicle 802 may desire to change lanes in front of the other vehicle 804. In a purely driver-controlled scenario, the driver may be tempted to cut closely in front of the other vehicle 804. Depending on the velocity/acceleration of the other vehicle 804, this may present a dangerous situation. The use of SDM in a driver-operated vehicle allows for the system to preclude the driver from performing risky maneuvers, in ensuring that the lane changes made in a safe manner.

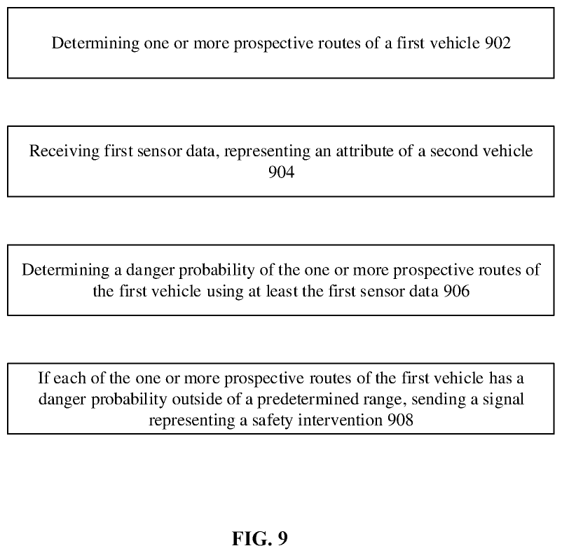

FIG. 9 depicts a method of risk assessment including: determining one or more prospective routes of a first vehicle 902; receiving first sensor data, representing an attribute of a second vehicle 904; determining a danger probability of the one or more prospective routes of the first vehicle using at least the first sensor data 906; and if each of the one or more prospective routes of the first vehicle has a danger probability outside of a predetermined range, sending a signal representing a safety intervention 908.

According to an aspect of the disclosure, a procedure for implementing a mathematical model (e.g., SDM) for ADAS evaluation may include: (1) updating the set of possible short-time route segments. If empty, creating new routes from a map starting at a current position fulfilling defined duration/distance. For existing routes: If not taken (evaluated by route vs. current position), remove; otherwise update (cut segment already taken and extend route to fulfill minimum duration/distance criteria). (2) For all possible route segments: calculate SDM state by creating situations using the particular route segment; check if dangerous and get the proper response. (3) Evaluate route SDM states: if there is at least one safe route, continue and remember the (last) safe one; if there are none, invoke SDM unsafe state handling from either the route that was the last safe one the most likely route based on probability measures.

Available routes may be duplicated to account for a plurality of possible actions of one or more other vehicles. Routes may be preliminarily obtained based on one or more possible actions of the ego vehicle, as depicted, for example, in FIG. 3. As described with respect to this figure, the ego vehicle may proceed straight ahead or make a left turn, thereby creating to possible routes. For each of these routes, the other vehicle (depicted with respect to FIG. 3 as vehicle 306/vehicle 312) also has two potential routes: proceeding straight ahead, or making a right turn. Because a plurality of options for the other vehicle are possible, the determined routes (straightahead or left turn) may be duplicated to account for each of the other vehicle's potential routes. In this manner, four routes may be calculated, the routes being: (1) ego vehicle and other vehicle proceeds straightahead; (2) ego vehicle proceeds straightahead and other vehicle makes right turn; (3) ego vehicle makes left turn and other vehicle proceeds straightahead; and (4) ego vehicle makes left turn and other vehicle makes right turn.

As described with respect to duplication above, the one or more processors may be configured to include duplication in the step of identifying routes. That is, in determining one or more rounds to be considered, any general path of the Ego vehicle may be duplicated any number of times to consider the various possibilities of actions of one or more other vehicles.

The principles and methods disclosed herein may be implemented by one or more processors configured to determine one or more prospective routes of a first vehicle, the first vehicle being at least partially controlled by a human driver; receive first sensor data, representing one or more attributes of a second vehicle; determine a danger probability of the one or more prospective routes of the first vehicle using the at least the one or more attributes of the second vehicle from the first sensor data; and if each of the one or more prospective routes of the first vehicle has a danger probability outside of a predetermined range, send a signal representing a safety intervention. The one or more processors may be located in any location desired for the implementation. That is, the one or more processors may be located in the vehicle at least partially controlled by a human driver, in a central database, or in any other location.

Various methods may exist for determining one or more prospective routes of the first vehicle. The procedures and methods disclosed herein are not necessarily intended to be dependent on the specific methods, procedures, routines, and/or instructions used to determine the prospective routes of the first vehicle. Rather, once the prospective routes are determined, emphasis is placed on the manner in which the prospective routes are evaluated for safety, and at which thresholds, or under which circumstances, the underlying safety system takes action.

As an extension of this idea, it may be known to determine prospective vehicle routes through one or more safety driving models and/or one or more mapping or routing models. According to one aspect, safety driving models may be implemented to analyze driving/vehicle data and to make determinations about the relative safety of various actions and/or prospective actions. According to another aspect, mapping or routing models may be implemented to analyze available data representing at least a vicinity of the vehicle, and to map or create a representation of the vicinity of the vehicle based on said data. This may include identifying roadways and streets; identifying other vehicles; identifying obstacles; identifying hazards; identifying distances between vehicles; identifying velocities and/or accelerations; or otherwise. Any of these operations may optionally rely on one or more mapping or navigational databases including maps, map information, navigational information, or other information about roadways and/or topography. Additionally or alternatively, historical and/or contextual information may be used as information on which any of these operations may rely. Such historical and/or contextual information may include, but is not limited to, traffic patterns, traffic flow, traffic decisions, etc. Such information may be available from any source whatsoever.

Upon determining one or more prospective routes of the ego vehicle, the one or more processors may be configured to determine a probability that the one or more routes are true. This may be understand is a probability that the vehicle will follow a particular route of the one or more routes. Otherwise stated, this may be understood as a probability that the ego vehicle will proceed along a given route. It may optionally further be understood as a probability that the Ego vehicle will proceed along a given route and at least one other vehicle will proceed as predicted in the prospective route. That is, a prospective route may indicate both an action of the Ego vehicle and an action of at least one other vehicle. Evaluating the truth of a particular prospective route may denote evaluating the truth of both the prospective action of the ego vehicle and the prospect of action of the other vehicle.

The one or more processors may utilize any data source to evaluate the truth of a prospective route. In a vehicle that is at least partially controlled by a human driver, the SDM is unlikely to know the intentions of the human driver. Furthermore, the SDM is unlikely to know the intentions of a driver of another vehicle. Although a variety of prospective routes may be identified and assessed, very little information may be derivable from the routes themselves as to the intentions of the driver of the Io vehicle and/or the driver of the other vehicle. As such, the one or more processors may seek further information from any of a variety of sources. For example, the Ego vehicle may include a plurality of sensors, any or any combination of which may be used to evaluate the truth of a particular route. In greater detail, the ego vehicle is likely to include one or more image sensors (cameras, video cameras, lidar, etc.), which may capture image data of another vehicle. The image data may provide clues or information about the intentions of the driver of the other vehicle. For instance, if the other vehicle has activated a turn signal, it may be assumed that the other vehicle's driver intends to turn. If the other vehicle's brake light is illuminated, it may be assumed that the other driver intends to slow or stop. If the image data shows that the other vehicle has entered a turn only lane, or that the other vehicle's wheels are turned, it may be assumed that the other vehicle's driver intends to turn. In this manner, information about the location or actions of the other vehicle may be used to determine a likely action or intention of the other driver. These calculations may be performed in any way desired (historical information, weighting, artificial intelligence, routines, etc.), without limitation.

The one or more processors may be configured to evaluate each of the prospective routes for safety. This may include evaluating a likely result of the prospective route (i.e. whether the ego vehicle and the other vehicle taking the prospective actions will result in a collision). The SDM may already be equipped to evaluate likely outcomes or danger of any of a variety of routes or situations, and according to one aspect, the analyses and models available for the SDM may be utilized in an unmodified or generally unmodified state to predict the outcome of a given route between a vehicle at least partially operated by a human driver and at least one other vehicle.

In a conventional SDM, the one or more processors may be configured to send a safety intervention whenever a single prospective route is determined to be dangerous (i.e. likely to result in a collision or damage). The conventional SDM may operate by excluding dangerous options, such that the vehicle only takes options/routes that are deemed to be safe. In reality, the conventional SDM may cause braking, re-steering, or other driving modifications to preclude a potentially dangerous situation. This may be ineffective in vehicles that are at least partially operated by a human driver, as it is generally not necessary to exclude all possible risk from a vehicle at least partially operated by human driver.

Thus, rather than sending a safety intervention whenever any possible route is determined to be dangerous, the SDM according to an aspect of the disclosure may be configured to only send a safety intervention when all possible routes are dangerous. That is, assuming that at least one safe route is available, the SDM may permit the driver to proceed, unencumbered or generally unencumbered, with the expectation that the driver will select the safe option.

As the driving continues, one or more routes in the prospective routes will become unavailable. That is, the vehicle will have passed a point at which action needed to have been taken to travel along the prospective route (i.e. the driver past an intersection but did not turn, etc.). When a route is no longer a viable option, the route may be eliminated from the grouping of prospective routes. Were a driver to hypothetically select a dangerous route, the various safe options would become unavailable as the driver nears the dangerous scenario. The one or more processors may be configured to frequently repeatedly evaluate/reevaluate the prospective routes, deleting routes that are no longer viable options. As the driver continues toward a dangerous route, ultimately, the remaining prospective routes will be eliminated, leaving only the dangerous route. In this manner, it can no longer be stated that at least one prospective route is safe. Because no prospective route is safe, the one or more processors may be configured to issue a safety intervention.

The data for route determination may be from any source whatsoever. It has been stated that the ego vehicle is likely to have a plurality of sensors. Any sensor providing information about a vicinity of the vehicle and/or any other vehicles near the ego vehicle may be used. Such sensors may include, but are not limited to a camera, a video camera, a depth camera, LIDAR, RADAR, or any combination thereof.

The safety intervention may include a notification and/or an action.

Regarding the safety intervention as a notification, the one or more processors may be configured to notify the human driver of the prospective danger. The notification may be visual, audio, or otherwise. The notification may be in a dashboard, or in a windshield, through a speaker, on a mobile device, or through any other means whatsoever. The notification may include one or more prospective routes and/or dangers associated with the one or more prospective routes.

Should a driver receive such notification, the driver may be given an opportunity to respond to the notification. The response may include an acceptance (an agreement to the assessment of the danger), an ignoring of the notification, or a rejection of the notification (disagreeing with the conclusion that a future route is dangerous). If the driver accepts the notification or ignores the notification, the one or more processors may be configured to send an instruction to control the vehicle to take an appropriate action. Such actions may include, but are not limited to, steering, braking, or otherwise. The term safety intervention is used herein to include the notification and/or an action such as steering braking or otherwise.

The following describes an evaluation of driving according to a second aspect of the disclosure.

Evaluating a driver's driving style may be important to drivers, passengers of drivers, insurance companies, municipalities, and the like. To the extent that driving styles are analyzed, the current method of such analysis is based primarily on limited information after an untoward event, such as (1) general facts/statistics about a collision: (where a collisions happened; how the collision happened; the apportioned fault of the driver(s); the severity and cost of the action occurrence; how often such collisions have occurred, etc.); or (2) based on basic sensor input (usually GPS, speedometer, and/or brake sensor/accelerometer), which may be used to determine whether the driver speeding while driving, where the driver frequently travels, a frequency of hard acceleration or de-acceleration, etc. With this information, a basic rating for a specific customer may be obtained. These ratings have traditionally been used for insurance rates and the like, and they may incentivize improved driving by reducing cost.

A standard set of rules/principles may be used to perform these evaluations. According to one aspect of the disclosure, the standard set of rules may be according to a vehicle risk assessment, such as a risk assessment performed by an autonomous or a semi-autonomous vehicle. Autonomous or semi-autonomous vehicles are configured to receive sensor input from surroundings of the vehicle and to calculate risk and make decisions based on the sensor input. These systems already include a multitude of factors, weights, procedures, and/or algorithms to evaluate the sensor information, predict future behavior and/or determine related risk. Such systems may also be used to evaluate a driving behavior or to quantitatively assess safety of a given driving behavior or drivers.

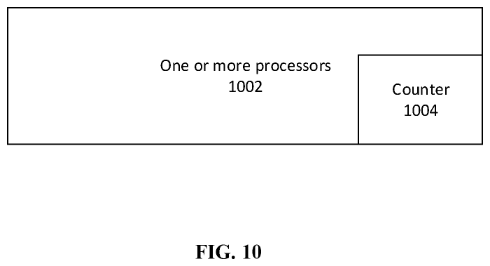

FIG. 10 depicts one or more processors 1002 configured to evaluate a vehicle action according to one or more driving safety models; and if a risk associated with the vehicle action is outside of a predetermined range, increment or decrement a counter 1004.

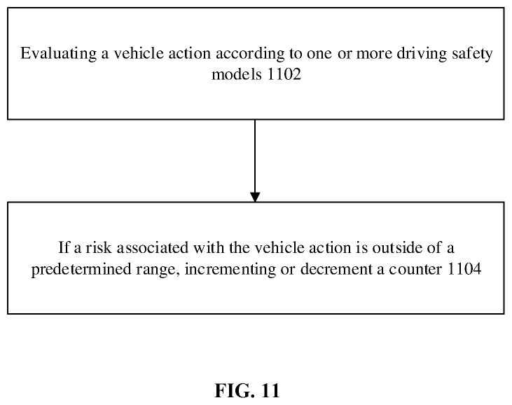

FIG. 11 depicts a method of driver safety assessment including: evaluating a vehicle action according to one or more driving safety models 1102; and if a risk associated with the vehicle action is outside of a predetermined range, incrementing or decrement a counter 1104.

According to one aspect, the Responsibility-Sensitive Safety (SDM) standards described above may be utilized to perform this quantitative analysis.

This disclosure includes the use of SDM as the embedded evaluation method to scoring the driver for his/her safety style, by counting the violations of SDM rules.

```
Global: Total_safety_violation = 0;
    //global count initialized to zero;
    Total_safety_violation_this_cycle = 0;
//SDM process keeps running in the background always
when the car is driving;
//SDM process will put is_SDM_triggered to true whenever
the system is
//under control of SDM function, and unset it after leaving
the control
//and also, SDM process will also increase the times counter
every time SDM
//is triggered.
SDM_timer_func_incurred_every_second( ){
    if is_SDM_triggered then {
Total_violation_trip = Total_violation_trip + 1;
Sub_cat_violation_counting( );
//add more details to the user about what violation
//actually it is, e.g.
//car following, or cut in, or others
Total_safety_violation_this_cycle =
Total_safety_violation_this_cycle + 1;
Total_safety_violation = Total_safety_violation + 1;
}
  }
Trip_start( ){ //every time a trip is started, trip_start( )
will be called
    Total_violation_trip = 0;
//user just start a new trip
}
Trip_stop( ){ //every time a trip is ended, trip_stop( ) will be called
    Display_safety_score_last_trip (Total_violation_trip);
    If display_more then Display_detailed_cat( );
    // show more details to the driver
    Display_safety_score_this_cycle (Total_safety_violation_
    this_cycle);
    //acknowledge the customer about the score
}
Inititiate_new_cycle( ){
    Total_safety_violation_this_cycle = 0;
    // start a new cycle, reset the count
}
```

Use of SDM as the embedded evaluation method for scoring of the driver for his/her safety style, by counting the violations of SDM rules provides a more objective and quantitative measure.

It can provide a clear, rule-based, easy to understand way for the driver to know his/style and know where he/she can improve;

For the insurers, compared to GPS and other approaches, this may provide better results (safety as the sole focus, and have clearer score, even no accidents are actually happening) while eliminating the necessity of intruding a customer's privacy;

This approach, coupled with communication links, which is now almost ubiquitous in the vehicle or in the near future, can provide a real-time info for the insurers, thus eliminating long delays.

A score can be displayed every time after a trip is finished. The displayed info can include: 1. An overall score of a last trip; 2. If not 100% safe, the score may include recommendations for improvement. To deliver the recommendations for improvement, the one or more processors may be further configured to log the cause of a counter increment (i.e., the situation that triggered the SDM to react). The driver may then be presented with this logged data in any way desired. According to an aspect of the disclosure, this information may be displayed/provided to the driver in real-time, such as when the driver performs an action that triggers the SDM. Additionally or alternatively, the driver may be provided with the information that triggered the SDM at the end of a trip, at the beginning of a trip, periodically (i.e., every week, every month, etc.) or in any other frequency. According to an aspect of the disclosure, the one or more processors may be configured to prepare a summary of the driver's driving and/or related driving score and provide periodic or occasional summary of this information to the driver. Said summaries may be provided, for example, via email. Specific examples of actions that may trigger the SDM include, but are not limited to, following too closely, cutting too closely in front or behind a vehicle, turning in front of a vehicle, etc.

```
Global: Total_safety_violation = 0;
    //global count initialized to zero;
    Total_safety_violation_this_cycle = 0;
//SDM process keeps running in the background always when
the car is driving;
//SDM process will put is_SDM_triggered to true whenever
the system is
//under control of SDM function, and unset it after leaving
the control
//and also, SDM process will also increase the times counter
every time SDM
//is triggered.
SDM_timer_func_incurred_every_second( ){
    if is_SDM_triggered then {
Total_violation_trip = Total_violation_trip + 1;
Sub_cat_violation_counting( );
//add more details to the user about what violation
//actually it is, e.g.
//car following, or cut in, or others
Total_safety_violation_this_cycle =
Total_safety_violation_this_cycle + 1;
Total_safety_violation = Total_safety_violation + 1;
}
  }
Trip_start( ){ //every time a trip is started, trip_start( )
will be called
    Total_violation_trip = 0;
//user just start a new trip
}
Trip_stop( ){ //every time a trip is ended, trip_stop( ) will
be called
    Display_safety_score_last_trip (Total_violation_trip);
    If display_more then Display_detailed_cat( );
    // show more details to the driver
    Display_safety_score_this_cycle (Total_safety_violation_
    this_cycle);
    //acknowledge the customer about the score
}
Inititiate_new _cycle( ){
    Total_safety_violation_this_cycle = 0;
    // start a new cycle, reset the count
}
```

The above procedure may yield descriptions of how safely a driver operates a vehicle. This may be calculated at any interval desired, such as, but not limited to every trip, every insurance cycle, or any other defined cycle, or even a cumulative total. The resulting score may provide feedback to drivers. Such feedback may communicate, for example, improvement or worsening of the score/driving practices, which may lead to overall safer driving.

According to an aspect of the disclosure, one or more applications may use these data. The data may be analyzed to show how a driver performed in a last assessment or period of assessments, or how the driver's analysis/score compares to previous analyses/scores. According to one aspect of the application, this may be performed via a user device (e.g., smartphone, tablet, etc.) or other software application.

In addition, the principles and methods disclosed herein may be used to compare the drivers in a region. For example, a driver's score may be compared to an average score (whether local average, city/state/national average, global average, or any other average). The scores may be posted to social media (assuming approval of the necessary parties). According to an aspect of the disclosure, the scores may be used in fleet services or for-hire services. For example, taxi drivers, livery drivers, ride-hailing service (e.g. Uber, Lyft, etc.) drivers may accrue driving scores, which may then become publically available. Prospective passengers may be given the opportunity to select one or more drivers for such services based on the driving score. This may have the effect of incentivizing good driving, as drivers with the best driving habits would ostensibly be rewarded with better business.

According to one aspect, the driver evaluation may be tracked by means of a simple counter. That is, the one or more processors may be configured to increment a counter whenever a safety intervention is issued.

The counter may be reset periodically, such as at the beginning of each trip. In this manner, the score of the given trip may be calculated in averaged.

According to another aspect, and should it be desired to have a more standardized assessment, the value of the counter may be further standardized to include an overall score which can be compared to the scores of other persons. In the configuration in which the counter resets with every trip, it would be expected that the average scores of persons who take frequent short trips may be lower than the average scores of persons who take infrequent long trips, as the long trips may provide more opportunities to reach a higher score before the counter is reset. Thus, drivers who operate the vehicle for longer periods may appear to be less safe than drivers who operate the vehicle for shorter periods. This may be corrected through any means of standardization that may be desired, without limitation.

According to an aspect of the disclosure, the score, whether raw or standardized, may be displayed to a driver of the vehicle. That is, the driver may receive real-time feedback about a driver's score. This may provide an incentive to the driver to improve the driver's driving habits.

According to certain aspects of the disclosure, the one or more processors may be configured to send a signal representing a safety intervention if each of the one or more prospective routes of the first vehicle has a danger probability outside of a predetermined range. Depending on the implementation, the one or more processors may be alternatively configured to send a signal representing a safety intervention if fewer than all of the one or more prospective routes of the first vehicle has a danger probability outside of a predetermined range. This may include a subset of the one or more prospective routes having a probability outside of a predetermined range. It is expressly disclosed that any method or any action of the one or more processors that is disclosed herein as being performed when each of the one or more prospective routes of the first vehicle has a danger probability outside of a predetermined range may alternatively be performed when fewer than all of the one or more prospective routes of the first vehicle has a danger probability outside of a predetermined range

In various portions of this disclosure, the one or more processors have been disclosed as utilizing first sensor data for one or more functions. This first sensor data has been referred to herein as including data from any of various sources, potentially including, but not limited to image sensor data. It is emphasized herein that the first sensor data may come from any source, without limitation. For example, the first sensor data may include any data from any vehicle sensor, without limitation. Additionally or alternatively, the first sensor data may include any data from any source outside of or beyond the first vehicle—such as information obtained via one or more wireless transmissions from an external source (i.e., from another vehicle, a wireless station, a transponder, a beacon, or from any other source of information, without limitation).

Additional aspects of the disclosure are made by way of example.

In Example 1, a safety system for a vehicle is disclosed, the safety system including: one or more processors configured to: determine one or more prospective routes of the vehicle, the first vehicle being at least partially controlled by a human driver; receive first sensor data, representing one or more attributes of a second vehicle; determine a danger probability of the one or more prospective routes of the first vehicle using the at least the one or more attributes of the second vehicle from the first sensor data; and if each of the one or more prospective routes of the first vehicle has a danger probability outside of a predetermined range, send a signal representing a safety intervention.

In Example 2, the safety system of Example 1 is disclosed, wherein the one or more processors are further configured to: receive second sensor data, representing a vicinity of the first vehicle; wherein the one or more processors determine the one or more prospective routes of the first vehicle from at least the second sensor data.

In Example 3, the safety system of Example 2 is disclosed, wherein the one or more processors determine the one or more prospective routes of the first vehicle from at least the second sensor data according to one or more mapping and routing models.

In Example 4, the safety system of Example 1 is disclosed, wherein the one or more processors are further configured to: receive second sensor data, representing a position of a first vehicle; receive map data, representing at least a vicinity of the first vehicle; and wherein the one or more processors determine the one or more prospective routes of the first vehicle from at least the first sensor data and the map data.

In Example 5, the safety system of Example 1 is disclosed, wherein the one or more processors are further configured to determine the one or more prospective routes of the first vehicle according to one or more mapping and routing modules.

In Example 6, the safety system of any one of Examples 1 to 5 is disclosed, wherein the one or more processors are further configured to: determine a probability of each of the prospective routes of the first vehicle being true; and if the danger probability of a most probable route is outside of the predetermined range, send a signal representing a safety intervention.

In Example 7, the safety system of any one of Examples 1 to 6 is disclosed, herein the first sensor data includes image sensor data representing an image of at least a portion of the second vehicle.

In Example 8, the safety system of Example 7 is disclosed, wherein the image sensor data includes data from at least one of a camera, a video camera, a depth camera, LIDAR, RADAR, or any combination thereof.

In Example 9, the safety system of any one of Examples 1 to 8 is disclosed, wherein the one or more processors are further configured to determine from the first sensor data at least one of an activated turn signal of the second vehicle, a change in velocity of the second vehicle, a wheel angle of the second angle, or any combination thereof.

In Example 10, the safety system of Example 9 is disclosed, wherein the one or more processors are further configured to determine the danger probability using at least the activated turn signal of the second vehicle, the change in velocity of the second vehicle, the wheel angle of the second angle, or any combination thereof.

In Example 11, the safety system of any one of Examples 1 to 10 is disclosed, wherein the one or more processors are further configured to determine from the first sensor data a presence of the second vehicle in a lane associated with a requirement for the second vehicle to perform an action, and wherein the one or more processors determine the danger probability using at least the requirement for the second vehicle to perform the action.

In Example 12, the safety system of any one of Examples 1 to 11 is disclosed, wherein the second sensor data includes positioning system data from one or more positioning sensors.

In Example 13, the safety system of Example 12 is disclosed, wherein the second sensor data includes data according to a Global Positioning System.

In Example 14, the safety system of any one of Examples 1 to 13 is disclosed, wherein the safety intervention includes at least one of braking, a change in velocity, a change in acceleration, a steering adjustment, or any combination thereof.

In Example 15, the safety system of any one of Examples 1 to 14 is disclosed, wherein the safety intervention includes a warning to a driver.

In Example 16, the safety system of any one of Examples 1 to 15 is disclosed, wherein the one or more prospective routes include one or more available routes of travel of the first vehicle.

In Example 17, the safety system of any one of Examples 1 to 16 is disclosed, wherein the one or more prospective routes further include one or more available actions of the second vehicle for each of the one or more available routes of travel of the first vehicle.

In Example 18, the safety system of any one of Examples 1 to 17 is disclosed, wherein the one or more processors are further configured to receive response data, representing a driver response to the safety intervention.

In Example 19, the safety system of Example 18 is disclosed, wherein the one or more processors are further configured to send a signal to control the first vehicle to receive response data, representing a driver response to the safety intervention.

In Example 20, the safety system of any one of Examples 1 to 19 is disclosed, wherein the first vehicle is at least partially controlled by a driver.

In Example 21, a method of risk assessment for a vehicle is disclosed, the method including: determining one or more prospective routes of a first vehicle; receiving first sensor data, representing an attribute of a second vehicle; determining a danger probability of the one or more prospective routes of the first vehicle using at least the first sensor data; and

if each of the one or more prospective routes of the first vehicle has a danger probability outside of a predetermined range, sending a signal representing a safety intervention.

In Example 22, the method of Example 21 is disclosed, further including: receiving second sensor data, representing a vicinity of the first vehicle; wherein the one or more processors determine the one or more prospective routes of the first vehicle from at least the second sensor data.

In Example 23, the method of Example 22 is disclosed, wherein the one or more prospective routes of the first vehicle are determined from at least the second sensor data according to one or more mapping and routing models.

In Example 24, the method of Example 21 is disclosed, further including receiving second sensor data, representing a position of a first vehicle; receiving map data, representing at least a vicinity of the first vehicle; and wherein the one or more prospective routes of the first vehicle are determined from at least the first sensor data and the map data.

In Example 25, the method of any one of Examples 21 to 24 is disclosed, further including: determining a probability of each of the prospective routes of the first vehicle being true; and if the danger probability of a most probable route is outside of the predetermined range, sending a signal representing a safety intervention.

In Example 26, the method of any one of Examples 21 to 20 is disclosed, wherein the first sensor data includes image sensor data representing an image of at least a portion of the second vehicle.

In Example 27, the method of Example 26 is disclosed, wherein the image sensor data includes data from at least one of a camera, a video camera, a depth camera, LIDAR, RADAR, or any combination thereof.

In Example 28, the method of any one of Examples 21 to 27 is disclosed, further including determining from the first sensor data at least one of an activated turn signal of the second vehicle, a change in velocity of the second vehicle, a wheel angle of the second angle, or any combination thereof.

In Example 29, the method of Example 28 is disclosed, further including determining the danger probability using at least the activated turn signal of the second vehicle, the change in velocity of the second vehicle, the wheel angle of the second angle, or any combination thereof.

In Example 30, the method of any one of Examples 21 to 29 is disclosed, further including determining from the first sensor data a presence of the second vehicle in a lane associated with a requirement for the second vehicle to perform an action, and wherein the one or more processors determine the danger probability using at least the requirement for the second vehicle to perform the action.

In Example 31, the method of any one of Examples 21 to 30 is disclosed, wherein the second sensor data includes positioning system data from one or more position sensors.

In Example 32, the method of Example 31 is disclosed, wherein the second sensor data includes data according to a Global Positioning System.

In Example 33, the method of any one of Examples 21 to 32 is disclosed, wherein the safety intervention includes at least one of braking, a change in velocity, a change in acceleration, a steering adjustment, or any combination thereof.

In Example 34, the method of any one of Examples 21 to 33 is disclosed, wherein the safety intervention includes a warning to a driver.

In Example 35, the method of any one of Examples 21 to 34 is disclosed, wherein the one or more prospective routes include one or more available routes of travel of the first vehicle.

In Example 36, the method of any one of Examples 21 to 35 is disclosed, wherein the one or more prospective routes further include one or more available actions of the second vehicle for each of the one or more available routes of travel of the first vehicle.

In Example 37, the method of any one of Examples 21 to 36 is disclosed, further including receiving response data, representing a driver response to the safety intervention.

In Example 38, the method of Example 37 is disclosed, further including sending a signal to control the first vehicle to receive response data, representing a driver response to the safety intervention.

In Example 39, one or more non-transient computer readable media including instructions which, when executed, are configured to cause one or more processors to perform the method of any one of Examples 21 to 38 are disclosed.

In Example 40, a vehicle risk-assessment system is disclosed, including: one or more processors configured to evaluate a vehicle action according to one or more driving safety models; and if a risk associated with the vehicle action is outside of a predetermined range, increment or decrement a counter.

In Example 41, the vehicle risk-assessment system of Example 40 is disclosed, wherein the one or more processors are further configured to reset the counter upon beginning a trip.

In Example 42, the vehicle risk-assessment system of Example 40 or 41 is disclosed, wherein the one or more processors are further configured to send a signal representing a value of the counter.

In Example 43, the vehicle risk-assessment system of any one of Examples 40 to 42 is disclosed, wherein the one or more processors are further configured to display the value of the counter.

In Example 44, the vehicle risk-assessment system of any one of Examples 40 to 43 is disclosed, wherein the one or more processors are further configured to store the value of the counter in one or more databases.

In Example 45, a method of driver safety assessment is disclosed including: evaluating a vehicle action according to one or more driving safety models; and if a risk associated with the vehicle action is outside of a predetermined range, incrementing or decrement a counter.

In Example 46, the method of driver safety assessment including of Example 45 is disclosed, further including resetting the counter upon beginning a trip.

In Example 47, the method of driver safety assessment including of Example 45 or 46 is disclosed, further including sending a signal representing a value of the counter.

In Example 48, the method of driver safety assessment including of any one of Examples 45 to 47 is disclosed, further including displaying the value of the counter.

In Example 49, the method of driver safety assessment including of any one of Examples 45 to 48 is disclosed, further including storing the value of the counter in one or more databases.

In Example 50, the method of Example 28 is disclosed, wherein the first sensor data includes data obtained from a vehicle-to-vehicle communication.

In Example 51, a vehicle control system for a vehicle is disclosed, the safety system including: a safety system, including one or more processors configured to: determine one or more prospective routes of the vehicle, the first vehicle being at least partially controlled by a human driver; receive first sensor data, representing one or more attributes of a second vehicle; determine a danger probability of the one or more prospective routes of the first vehicle using the at least the one or more attributes of the second vehicle from the first sensor data; and if each of the one or more prospective routes of the first vehicle has a danger probability outside of a predetermined range, send a signal representing a safety intervention to a control system; and the control system, configured to control a vehicle to perform one or more safety operations in response to the signal representing the safety intervention.

In Example 52, the vehicle control system of Example 51 is disclosed, wherein the one or more processors are further configured to: receive second sensor data, representing a vicinity of the first vehicle; wherein the one or more processors determine the one or more prospective routes of the first vehicle from at least the second sensor data.

In Example 53, the vehicle control system of Example 51 or 52 is disclosed, wherein the one or more processors determine the one or more prospective routes of the first vehicle from at least the second sensor data according to one or more mapping and routing models.

In Example 54, the vehicle control system of any one of Examples 51 to 53 is disclosed, wherein the one or more processors are further configured to: receive second sensor data, representing a position of a first vehicle; receive map data, representing at least a vicinity of the first vehicle; and wherein the one or more processors determine the one or more prospective routes of the first vehicle from at least the first sensor data and the map data.

In Example 55, the vehicle control system of any one of Examples 51 to 54 is disclosed, wherein the one or more processors are further configured to: determine for each of the prospective routes a probability that the first vehicle will follow the prospective route; and if the danger probability of a most probable route is outside of the predetermined range, send a signal representing a safety intervention.

In Example 56, the vehicle control system of any one of Examples 51 to 55 is disclosed, wherein the first sensor data includes image sensor data representing an image of at least a portion of the second vehicle, wherein the image sensor data includes data from at least one of a camera, a video camera, a depth camera, LIDAR, RADAR, or any combination thereof.

In Example 57, the vehicle control system of any one of Examples 51 to 56 is disclosed, wherein the one or more processors are further configured to determine from the first sensor data at least one of an activated turn signal of the second vehicle, a change in velocity of the second vehicle, a wheel angle of the second angle, or any combination thereof, and wherein the one or more processors are further configured to determine the danger probability using at least the activated turn signal of the second vehicle, the change in velocity of the second vehicle, the wheel angle of the second angle, or any combination thereof.

In Example 58, the vehicle control system of any one of Examples 51 to 57 is disclosed, wherein the one or more processors are further configured to determine from the first sensor data a presence of the second vehicle in a lane associated with a requirement for the second vehicle to perform an action, and wherein the one or more processors determine the danger probability using at least the requirement for the second vehicle to perform the action.

In Example 59, the vehicle control system of any one of Examples 51 to 58 is disclosed, wherein the one or more processors are further configured to receive response data, representing a driver response to the safety intervention.

In Example 60, the vehicle control system of Example 59 is disclosed, wherein the one or more processors are further configured to send a signal to control the first vehicle to receive response data, representing a driver response to the safety intervention.

In Example 61, the vehicle control system of any one of Examples 51 to 60 is disclosed, wherein controlling the vehicle to perform the one or more safety operations in response to the signal representing the safety intervention includes controlling the vehicle to reduce a velocity, reduce an acceleration, brake, change a steering direction, or any combination thereof.

In Example 62, a vehicle is disclosed including: a safety system, including one or more processors configured to: determine one or more prospective routes of the vehicle, the first vehicle being at least partially controlled by a human driver; receive first sensor data, representing one or more attributes of a second vehicle; determine a danger probability of the one or more prospective routes of the first vehicle using the at least the one or more attributes of the second vehicle from the first sensor data; and if each of the one or more prospective routes of the first vehicle has a danger probability outside of a predetermined range, send a signal representing a safety intervention to a control system; and the control system, configured to control a vehicle to perform one or more safety operations in response to the signal representing the safety intervention.

In Example 63, the vehicle of Example 62 is disclosed, wherein the one or more processors are further configured to: receive second sensor data, representing a vicinity of the first vehicle; wherein the one or more processors determine the one or more prospective routes of the first vehicle from at least the second sensor data.

In Example 64, the vehicle of Example 62 or 63 is disclosed, wherein the one or more processors determine the one or more prospective routes of the first vehicle from at least the second sensor data according to one or more mapping and routing models.

In Example 65, the vehicle of any one of Examples 62 to 64 is disclosed, wherein the one or more processors are further configured to: receive second sensor data, representing a position of a first vehicle; receive map data, representing at least a vicinity of the first vehicle; and wherein the one or more processors determine the one or more prospective routes of the first vehicle from at least the first sensor data and the map data.

In Example 66, the vehicle of any one of Examples 62 to 65 is disclosed, wherein the one or more processors are further configured to: determine for each of the prospective routes a probability that the first vehicle will follow the prospective route; and if the danger probability of a most probable route is outside of the predetermined range, send a signal representing a safety intervention.

In Example 67, the vehicle of any one of Examples 62 to 66 is disclosed, wherein the first sensor data includes image sensor data representing an image of at least a portion of the second vehicle, wherein the image sensor data includes data from at least one of a camera, a video camera, a depth camera, LIDAR, RADAR, or any combination thereof.

In Example 68, the vehicle of any one of Examples 62 to 67 is disclosed, wherein the one or more processors are further configured to determine from the first sensor data at least one of an activated turn signal of the second vehicle, a change in velocity of the second vehicle, a wheel angle of the second angle, or any combination thereof, and wherein the one or more processors are further configured to determine the danger probability using at least the activated turn signal of the second vehicle, the change in velocity of the second vehicle, the wheel angle of the second angle, or any combination thereof.

In Example 69, the vehicle of any one of Examples 62 to 68 is disclosed, wherein the one or more processors are further configured to determine from the first sensor data a presence of the second vehicle in a lane associated with a requirement for the second vehicle to perform an action, and wherein the one or more processors determine the danger probability using at least the requirement for the second vehicle to perform the action.

In Example 70, the vehicle of any one of Examples 62 to 69 is disclosed, wherein the one or more processors are further configured to receive response data, representing a driver response to the safety intervention.

In Example 71, the vehicle of Example 70 is disclosed, wherein the one or more processors are further configured to send a signal to control the first vehicle to receive response data, representing a driver response to the safety intervention.

In Example 72, the vehicle of any one of Examples 62 to 71 is disclosed, wherein controlling the vehicle to perform the one or more safety operations in response to the signal representing the safety intervention includes controlling the vehicle to reduce a velocity, reduce an acceleration, brake, change a steering direction, or any combination thereof.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A safety system for a vehicle, the safety system comprising:
one or more processors configured to:
determine one or more prospective routes of the vehicle, the first vehicle being at least partially controlled by a human driver;
receive first sensor data, representing one or more attributes of a second vehicle;
determine a danger probability of the one or more prospective routes of the first vehicle using the at least the one or more attributes of the second vehicle from the first sensor data; and
if each of the one or more prospective routes of the first vehicle has a danger probability outside of a predetermined range, send a signal representing a safety intervention.

2. The safety system of claim 1, wherein the one or more processors are further configured to:
receive second sensor data, representing a vicinity of the first vehicle;
wherein the one or more processors determine the one or more prospective routes of the first vehicle from at least the second sensor data.

3. The safety system of claim 2, wherein the one or more processors determine the one or more prospective routes of the first vehicle from at least the second sensor data according to one or more mapping and routing models.

4. The safety system of claim 1, wherein the one or more processors are further configured to:
receive second sensor data, representing a position of a first vehicle;
receive map data, representing at least a vicinity of the first vehicle; and
wherein the one or more processors determine the one or more prospective routes of the first vehicle from at least the first sensor data and the map data.

5. The safety system of claim 1, to wherein the one or more processors are further configured to:
determine for each of the prospective routes a probability that the first vehicle will follow the prospective route; and
if the danger probability of a most probable route is outside of the predetermined range, send a signal representing a safety intervention.

6. The safety system of claim 1, wherein the first sensor data comprises image sensor data representing an image of at least a portion of the second vehicle, wherein the image sensor data comprises data from at least one of a camera, a video camera, a depth camera, LIDAR, RADAR, or any combination thereof.

7. The safety system of claim 1, wherein the one or more processors are further configured to determine from the first sensor data at least one of an activated turn signal of the second vehicle, a change in velocity of the second vehicle, a wheel angle of the second angle, or any combination thereof, and wherein the one or more processors are further configured to determine the danger probability using at least the activated turn signal of the second vehicle, the change in velocity of the second vehicle, the wheel angle of the second angle, or any combination thereof.

8. The safety system of claim 1, wherein the one or more processors are further configured to determine from the first sensor data a presence of the second vehicle in a lane associated with a requirement for the second vehicle to perform an action, and wherein the one or more processors determine the danger probability using at least the requirement for the second vehicle to perform the action.

9. The safety system of claim 1, wherein the one or more processors are further configured to receive response data, representing a driver response to the safety intervention.

10. The safety system of claim 9, wherein the one or more processors are further configured to send a signal to control the first vehicle to receive response data, representing a driver response to the safety intervention.

11. A method of risk assessment for a vehicle, the method comprising:
determining one or more prospective routes of a first vehicle;
receiving first sensor data, representing an attribute of a second vehicle;
determining a danger probability of the one or more prospective routes of the first vehicle using at least the first sensor data; and
if each of the one or more prospective routes of the first vehicle has a danger probability outside of a predetermined range, sending a signal representing a safety intervention.

12. The method of claim 11, further comprising:
receiving second sensor data, representing a vicinity of the first vehicle;
wherein the one or more processors determine the one or more prospective routes of the first vehicle from at least the second sensor data.

13. The method of claim 11, further comprising:
determining a probability of each of the prospective routes of the first vehicle being true; and
if the danger probability of a most probable route is outside of the predetermined range, sending a signal representing a safety intervention.

14. A vehicle risk-assessment system comprising:
one or more processors configured to
evaluate a vehicle action according to one or more driving safety models; and
if a risk associated with the vehicle action is outside of a predetermined range, increment or decrement a counter.

15. The vehicle risk-assessment system of claim 16, wherein the one or more processors are further configured to reset the counter upon beginning a trip.

16. The vehicle risk-assessment system of claim 16, wherein the one or more processors are further configured to send a signal representing a value of the counter.

17. The vehicle risk-assessment system of claim 16, wherein the one or more processors are further configured to display the value of the counter.

18. The vehicle risk-assessment system of claim 16, wherein the one or more processors are further configured to store the value of the counter in one or more databases.

19. A method of driver safety assessment comprising:
evaluating a vehicle action according to one or more driving safety models; and
if a risk associated with the vehicle action is outside of a predetermined range, incrementing or decrement a counter.

20. The method of driver safety assessment comprising of claim 21, further comprising resetting the counter upon beginning a trip.

21. The method of driver safety assessment comprising of claim 21, further comprising sending a signal representing a value of the counter.

22. The method of driver safety assessment comprising of claim 21, further comprising displaying the value of the counter.

23. The method of driver safety assessment of claim 21, further comprising storing the value of the counter in one or more databases.

24. (canceled)

25. (canceled)
